(19) United States
(12) Patent Application Publication
(10) Pub. No.: US 2006/0007455 A1
(43) Pub. Date: Jan. 12, 2006

(54) Method for increasing the efficiency of color management in job ticket workflows

(75) Inventor: Martin Bailey, Cambridge (GB)

Correspondence Address: DARBY & DARBY P.C., P. O. BOX 5257, NEW YORK, NY, 10150-5257, US

(73) Assignee: GLOBAL GRAPHICS SOFTWARE, INC., Cambridge (GB)

(21) Appl. No.: 11/165,822

(22) Filed: Jun. 23, 2005

Related U.S. Application Data
(60) Provisional application No. 60/582,860, filed on Jun. 25, 2004.

(51) Int. Cl. G06F 15/00

(52) U.S. Cl. 358/1.9

(57) ABSTRACT

Methods and systems for printing a print job include obtaining converted color profiles. Such methods include using a customized URL scheme, a predefined sequence in a URL that directs a processor to the converted color profile or a dynamic construction of mapping URLs to converted color profiles.

### CROSS-REFERENCE TO RELATED APPLICATIONS

This application claims the benefit of U.S. Provisional Patent Application No. 60/582,860, filed on Jun. 25, 2004; which application is incorporated herein by reference in its entirety.

### FIELD

The present application is directed to methods and systems for managing and providing color profiles for a print job. In addition the present application is directed to methods and systems for efficiently managing and providing converted color profiles for a print job.

### BACKGROUND

Increasingly workflows in the graphic arts are controlled by using a computer file that contains information and instructions for the processing of a print job. This file is referred to as an electronic job ticket. While some information, such as job number time, date, customer identification, and billing, may be included directly in the electronic job ticket, other information may be in separate files that are referenced in the job ticket. Typically job information such as the content to be printed, graphic (including text), font definitions, and color profiles (discussed below) are too bulky to be embedded in the job ticket. Instead the job ticket includes a reference to another file that contains the additional information. One application is used to generate the job ticket (generating application) and another application is used to process the job ticket (reading application). Some of the popularity of this approach is due to the publication of the Job Definition Format (JDF) by the CIP4 organization. JDF is a portable and standard method of defining electronic job tickets for print production.

One important aspect of printing is color management. The colors that appear on a computer monitor or printed paper are affected by the way that the monitor or printer interprets and produces colors. A color profile is used to correctly render the colors of the graphical content for the specific output media. One format for color profiles is defined by the International Color Consortium (ICC).

The ICC color management model is based on a conversion of all color data from a source device-dependent color space into a device independent color space called the “profile connection space” (PCS), and then a conversion into an output device-dependent color space that reflects the physical characteristics of the output device (e.g., a printing press or other printer). Conversion from source device dependent space (e.g., RGB or CMYK) into PCS uses data taken from a source color profile. Conversion from PCS to the output-device-specific color space uses data taken from a target color profile.

The color profile contains the color values and formulas transforming absolute color values into device dependent color spaces such as Red/Green/Blue (RGB) or Cyan/Magenta/Yellow/Black (CMYK), and vice versa. Values defined in a device dependent color space may be visually different when displayed on different devices, because the effect of, e.g. 50% coverage of ‘Cyan’, may be different. As a non-technical example, consider that toasting slices of bread from the same loaf in a number of different toasters, all with their ‘brownness’ dials set to the same number, will usually produce some slices that are barely even warmed, while others may be burnt. Color transformations, defined in the color profile, may be used as source profiles, where, for instance, the colors of an image file captured by a digital camera in RGB are transformed into absolute colors. The color transformations may also be used as target profiles, where, for instance, the job file specifies absolute colors, which need to be adjusted to compensate for the effects of different inks or paper in a color printer or on a printing press. The color profile for a particular job may be stored in a separate file that is referenced in the electronic job ticket.

Often a fairly small number of standard color profiles will be used for many jobs. Many RGB images from digital cameras, for instance, are transformed using a profile for sRGB. Many CMYK scans, especially in North America, are prepared for SWOP (Specifications for Web Offset Publications) and therefore should be transformed through a color profile prepared for SWOP. The jobs proofed on a particular combination of printer, paper and ink would typically use a color profile produced for that combination.

### BRIEF SUMMARY

One embodiment is a method for printing a print job. The method includes providing a profile table and a first universal resource locator (URL) scheme. A URL is obtained for the color profile. The URL has a scheme portion. The profile table is queried, if the scheme portion of the URL comprises the first URL scheme, to determine an address of a converted color profile.

Another embodiment is a method for printing a print job. The method includes obtaining a universal resource locator (URL) for the color profile. The URL has an address portion which, if the address portion comprises a predefined sequence, directs the processor to obtain a converted color profile from a predefined address. The converted color profile is obtained from the predefined address if the address portion of the URL comprises the predefined sequence.

Yet another embodiment is a method for printing a print job. The method includes obtaining a universal resource locator (URL) for the color profile. If the color profile has not been previously encountered, the color profile is obtained and converted. If the color profile has been previously encountered, a previously-stored converted color profile is obtained.

Other embodiments include systems for printing a print job using one of the methods described above. The system includes a processor that performs the described method steps and may include a computer to generate or store the print job and a printer (e.g., a printing press or other printing device.)

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic illustration of a system for printing a print job, according to the invention;

FIG. 2 is a flow chart of one embodiment of a method of converting color profiles, according to the invention;

FIG. 3 is a flow chart of one embodiment of a method for obtaining a converted color profile, according to the invention;

FIG. 4 is a flow chart of another embodiment of a method for obtaining a converted color profile, according to the invention; and

FIG. 5 is a flow chart of a third embodiment of a method for obtaining a converted color profile, according to the invention.

### DETAILED DESCRIPTION

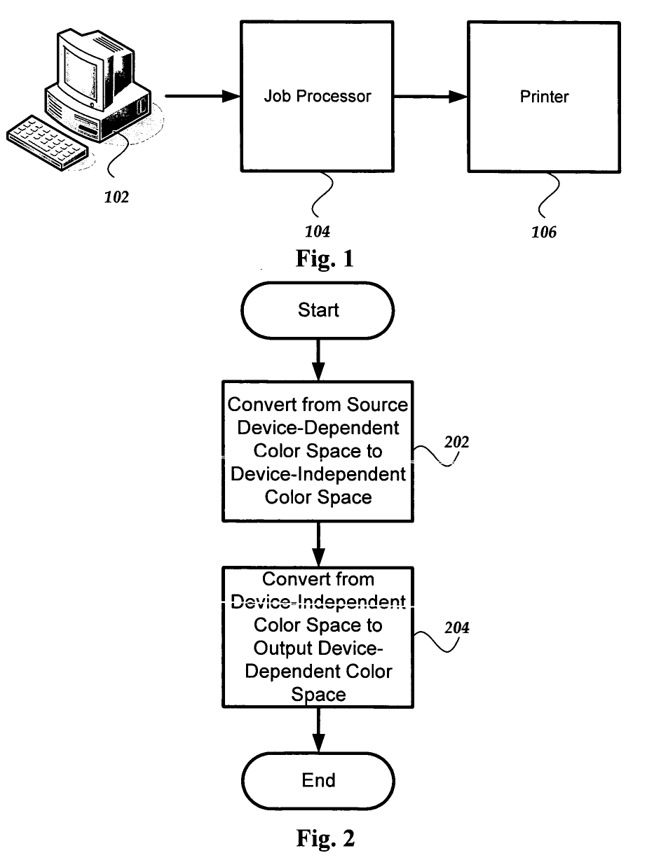

The present application is directed to methods and systems for managing and providing color profiles for a print job. In addition the present application is directed to methods and systems for efficiently managing and providing converted color profiles for a print job. FIG. 1 illustrates one embodiment of a system for printing proofs. A computer 102 generates or stores the image to be used for the proof. The job containing the image is generated on the computer 102. The job is provided to a job processor 104 (such as a Raster Image Processor (RIP)) to convert the job into a format suitable for the printer 106. The printer 106 can be a printing press or any other printing device. In one embodiment, printing is done directly from the RIP to a color printer (for example, an ink-jet printer, a laser printer, or a printer using other printing technology). If printing on a conventional printing press the RIP can be used to image onto, for example, film or plates; if onto film, then that can be used to image plates, and the plates can then be mounted on the printing press to actually perform the printing process. In some cases, especially for printing on a digital production press or imaging printing plates, the RIP may save rasterized data on a computer disk, that will be output later, often by another piece of software (often called a “shooter”), onto the paper, film, or plate. In some embodiments, software other than the RIP is used to image pre-generated generated rasters and apply the color management. For example, the “shooter” can be the job processor 104.

As an example illustrated in FIG. 2, a source color profile file may be used to convert the job from a source device-dependent color space suitable for display on the monitor of the computer to a device independent color space (step 202) and a target color profile can be used to covert the job from the device independent color space to an output device-dependent color space usable by the printer (step 204). In some embodiments, a source device-dependent color space can be converted directly to an output device-dependent color space without passing through a device-independent color space.

The reference in a job ticket to an external color profile file may be a Uniform Resource Locator (URL). A URL provides a unique path to find a file within a local or wide-area network, wherever the file is stored. A standard URL has the following format: <scheme>:<address>. The <scheme> identifies the method (protocol) used to access or obtain the file or resource at the location defined by the URL. Common standard schemes are FILE, HTTP (hypertext transfer protocol) FTP (file transfer protocol), and CID (content identification). The “file:” scheme, for instance, means to use the operating system's file-reading procedures to access the file. The <address> is usually defined as a path through a network directory and file hierarchy which may include a specific file name. A URL may be absolute or relative. An absolute URL contains the full address identify where the file is located. A relative URL contains the file name but omits all or part of the address. Instead the address information for the file that contains the relative URL is applied to locate the file identified in the relative URL.

When a job ticket refers to a specific color profile identified by a URL, that profile should be used. In order to use a color profile the reading application must resolve the URL and obtain the file or data stream containing the profile data. In some cases it may also need to re-encode or otherwise adapt the profile data itself into a form more applicable for the way that it will apply the profile as a part of performing color management. Such obtaining of the referenced profile and re-encoding or adaptation is described here as “conversion”, and often involves storing the data as a file on another computer elsewhere in the network. Thus the profile stored on some computer in the network, and referred to by the job ticket, may be in a file format that is different from the format required by the reading application in order to perform the color transformations requested by the job ticket. Thus, when the profile is referenced using the URL, the profile is converted in a suitable representation for use with the color transformations. Obtaining the profile and converting among these file formats can be relatively expensive operations in terms of the time taken, and of the disk space and memory required.

The efficiency of workflows controlled by electronic job tickets that include color management using color profiles could be significantly improved if it were possible to avoid the need to process and convert every color profile for every job. Three mechanisms are presented here that enable pre-converted profiles to be used instead in many cases.

a) Custom Scheme: Explicit Use of a Custom URL Scheme Designed for the Purpose of Locating Color Profiles.

The invention defines a new scheme, e.g., “profile:”, that indicates a new method for accessing the appropriate color profile by using a look-up table. The look-up table (referred to here as a profile table) includes references to all the previously converted color profiles available to the reading application. The profile table contains a key and a reference. The key is the entire address portion of the URL. The reference identifies each converted color profile with a color-profile name. The profile table may be generated by the vendor of the reading application or generating application or by the end-user, with a tool supplied by that vendor. The profile table is typically stored on the computer executing the reading application. This computer may be the same or different from the computer where the profile table was generated.

The new scheme is formatted in the URL in the job ticket in the same way as standard schemes. The generating application is provided with access to the profile table. Alternatively, a duplicate profile table is provided for the generating application.

When the reading application encounters a URL in the job ticket with the “profile:” scheme, the application reads it as an instruction to look up the rest of the URL in the previously-constructed table of converted color profiles. The reading application recognizes the new scheme in the same way as the standard schemes. However, the status of the referenced file is implied by the scheme in use. For example, file scheme or http scheme in the context of a color profile reference implies that the referenced color profile file is in a non-converted format, e.g. the ICC profile format. A profile scheme implies that the color profile file is in a converted format. Thus, if an electronic job ticket included “profile:SWOP,” the URL is treated as a reference to the profile table. The application then accesses or queries the profile table for the SWOP definition. The SWOP definition indicated in the profile table or associated file applies to a CMYK color profile that has already been converted into an appropriate form for the application to use it for color transformations.

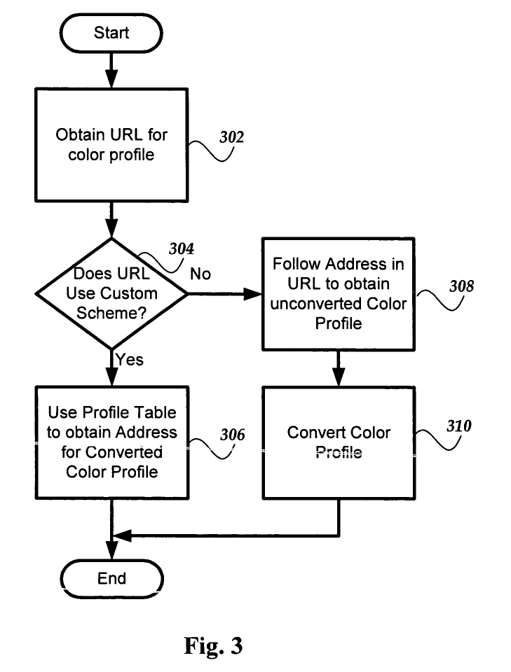

FIG. 3 provides a flow chart of one embodiment of a method for using a custom URL scheme. When processing the job ticket, the URL for the color profile is obtained from the job ticket (step 302). The processor determines whether the URL contains a custom scheme, such as “profile:” (step 304). If the URL does contain the custom scheme, then the processor consults a profile table to obtain the address for the converted color profile (step 306). If the URL does not contain the custom scheme, then the processor follows the address provided in the URL to obtain the unconverted color profile (step 308) and then converts the color profile (step 310). The converted color profile can then be used to print the job.

b) Explicit Use of Predefined URL Prefix Designed for Use with Color Profiles.

In the invention, the initial part of address identified in the URL is set to a pre-defined sequence of characters (referred to here as a prefix or sequence) that indicates a pre-converted color profile. The sequence is designed to be unique to avoid conflict with existing URLs accessible in the reading application's environment. The presence of the predefined sequence of characters indicates to the reading application to use a converted color profile. If the profile is not pre-converted the reading application converts the profile or instigates another application to convert the profile. The predefined sequence is accessible to both the job ticket generator and reader (generating and reading applications) in the same way and for the same reason as a custom URL scheme (see above). The predefined sequence may be used with a standard (existing) scheme or a custom (new) scheme, as described above.

For example, if the prefix has been defined to be “profiles/” and the relative URL is “profiles/SWOP,” the reading application treats the URL as a reference to the color profile for the SWOP definition of a CMYK color space that has already been converted into an appropriate form for the reading application to use for color transformations. The SWOP definition standardizes a set of characterization data, and multiple profiles may be generated that accurately reflect that characterization. The color management tool must be able to access an appropriate profile when instructed to emulate a SWOP press, and therefore such tools already include mappings from SWOP (and other definitions) to such a profile. The predefined prefix uniquely specifies the address for the file containing the pre-converted color profile. The converted profile is particular to the software used to perform the color management (precise configuration, printer model etc are unlikely to be relevant). The software vendor (or end-user) decides in advance which profile should be used when supplied with a URL using the predefined sequence. The converted color profile may be stored on the computer performing the color management or the computer processing the reading application, which may be the same computer. The reading application uses a look-up table to locate the color profile. The look-up table is similar to the profile (look-up) table; however the key is the address portion that follows the prefix instead of the complete address portion of the URL.

The reading application (and perhaps other locally operating applications) is designed or modified to recognize the predefined sequence in the URL. The reading application first determines whether the URL starts with the pre-defined prefix, then the application determines what scheme is used in the URL, if any. If the pre-defined prefix is present, the scheme need not be considered as a part of finding the pre-installed profile. For example, if the prefix is “http://www.globalgraphics.com/profiles/”, the reading application would recognize it and strip off the entire sequence to create a key to use in interrogating the look-up table. Thus the part of the URL that would otherwise be used to identify the scheme, e.g., http, is not used as a scheme. However, some implementations may make the un-converted profile available at the location identified by the URL, so that if the URL is treated as a regular URL, and the scheme is evoked, (e.g. by a reading application that does not incorporate this invention), at least the unconverted color profile may be used to process the job ticket.

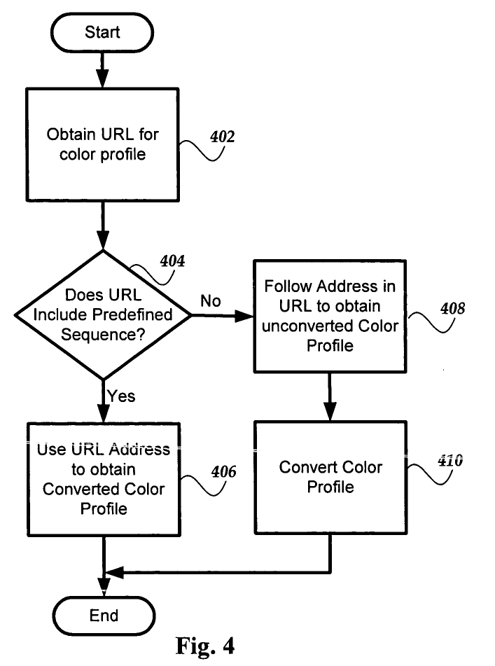

FIG. 4 provides a flow chart of one embodiment of a method for using a predefined sequence in a URL. When processing the job ticket, the URL for the color profile is obtained from the job ticket (step 402). The processor determines whether the URL contains the predefined sequence, such as “profiles/” (step 404). If the URL does contain the predefined sequence, then the processor uses the URL address (or consults a look-up table) to obtain the converted color profile (step 406). If the URL does not contain the predefined sequence, then the processor follows the address provided in the URL to obtain the unconverted color profile (step 408) and then converts the color profile (step 410). The converted color profile can then be used to print the job.

c) Dynamic Construction of a Mapping of URLs for Converted Color Profiles.

The reading application (that processes the job tickets and acts on color profiles) builds a mapping between the URL used for each color profile and the converted profile that it retains in memory or in its own disk cache. The mapping may be stored as a look-up table, e.g., in-memory (with back-up to a disk file) or as a disk file in the first instance. Each time the reading application encounters a URL identifying a color profile while processing a job ticket, the application checks the mapping to determine whether the appropriate converted color profile is available. If not, the converted color profile is generated, (stored locally) and the mapping is updated. If the same URL is encountered when processing a later job ticket, the application can then use the pre-converted color profile (stored locally) rather than having to convert the color profile identified by URL (and often remotely located). The steps are as follows: i) Check for previously encountered URLs; ii) If the supplied URL is new to the reading application, resolve the URL to the color profile file and convert it to the internal format for the color management engines; and iii) If the supplied URL has been encountered before, use the locally-stored converted color profile file.

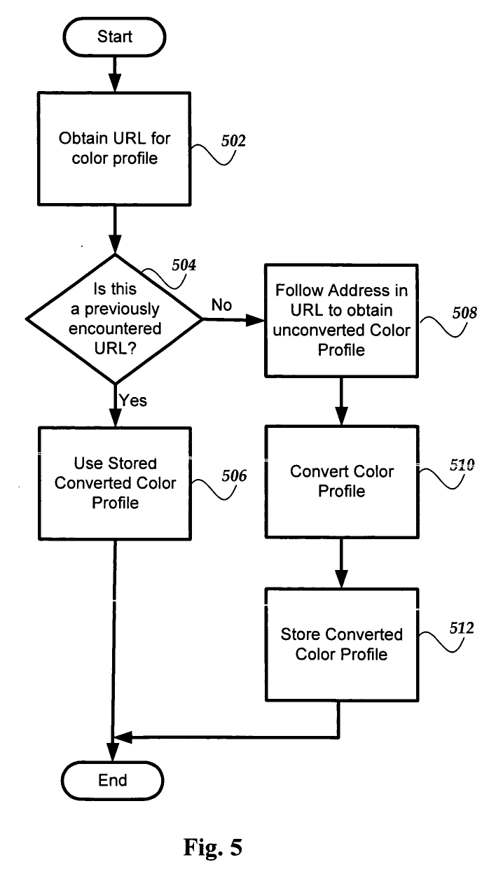

FIG. 5 provides a flow chart of one embodiment of a method for using a dynamic construction of URLs for converted color profiles. When processing the job ticket, the URL for the color profile is obtained from the job ticket (step 502). The processor determines whether the URL has been previously encountered and whether a converted color profile has been stored (preferably, stored locally) (step 504). This process may include referencing a look-up table or other file to determine whether a previously converted color profile is available. If a stored converted color profile exists, then the processor obtains the stored converted color profile (step 506). If a stored converted color profile does not exist, then the processor follows the address provided in the URL to obtain the unconverted color profile (step 508) and then converts the color profile (step 510). The converted color profile is then stored (preferably, stored locally) (step 512) for use when the URL is again called. The converted color profile can then be used to print the job.

These three different approaches have different strengths and weaknesses. The use of a custom scheme or a predefined URL prefix may require that job ticket generating application implement this approach in the same way as the job ticket reading application. On the other hand, these approaches provide a very clear statement that a particular color profile is to be used. The dynamically constructed map does not require cooperation between the creation and consuming tools (generating and reading applications), but might use the wrong profile if an existing color profile at the location identified by the URL was replaced with a new one.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method for printing a print job, the method comprising:
providing a profile table and a first universal resource locator (URL) scheme;
obtaining a URL for the color profile, the URL having a scheme portion; and
querying the profile table, if the scheme portion of the URL comprises the first URL scheme, to determine an address of a converted color profile.

2. The method of claim 1, further comprising obtaining an unconverted color profile if the scheme portion of the URL does not comprise the first URL scheme.

3. The method of claim 2, further comprising converting the unconverted color profile.

4. The method of claim 1, further comprising transforming color data of the print job using the converted color profile.

5. The method of claim 1, further comprising providing a print job and printing the print job using the converted version of the color profile.

6. The method of claim 1, wherein first URL scheme is a custom URL scheme.

7. A system for printing a print job, the system comprising:
a processor adapted to perform the method of claim 1.

8. A method for printing a print job, the method comprising:
obtaining a universal resource locator (URL) for the color profile, the URL having an address portion which, if the address portion comprises a predefined sequence, directs the processor to obtain a converted color profile from a predefined address; and
obtaining the converted color profile from the predefined address if the address portion of the URL comprises the predefined sequence.

9. The method of claim 8, further comprising obtaining an unconverted color profile using the URL if the address portion of the URL does not comprise the predefined sequence.

10. The method of claim 9, further comprising converting the unconverted color profile.

11. The method of claim 8, wherein obtaining the converted color profile comprises querying a look-up table to determine an address of the converted color profile.

12. The method of claim 8, further comprising providing a print job and printing the print job using the converted color profile.

13. A system for printing a print job, the system comprising:
a processor adapted to perform the method of claim 8.

14. A method for printing a print job, the method comprising:
obtaining a universal resource locator (URL) for the color profile;
if the color profile has not been previously encountered, obtaining and converting the color profile; and
if the color profile has been previously encountered, obtaining a previously-stored converted color profile.

15. The method of claim 14, if the color profile has not been previously encountered, storing the converted color profile.

16. The method of claim 14, further comprising consulting a look-up table to determine if the color profile has been previously encountered.

17. The method of claim 14, further comprising transforming color data of the print job using the converted color profile.

18. The method of claim 14, further comprising providing a print job and printing the print job using the converted color profile.

19. A system for printing a print job, the system comprising:
a processor adapted to perform the method of claim 14.

20. The system of claim 19, further comprising a computer and a printing device, each coupled to the processor.
